(19) United States
(12) Patent Application Publication
(10) Pub. No.: US 2004/0213997 A1
(43) Pub. Date: Oct. 28, 2004

(54) Aqueous preparations containing microencapsulated active components

(76) Inventors: Nuria Bonastre Gilabert, Barbera del Vall (ES); Augustin Sanchez, Barcelona (ES); Maria De Moragas, Barcelona (ES)

Correspondence Address: COGNIS CORPORATION, PATENT DEPARTMENT, 300 BROOKSIDE AVENUE, AMBLER, PA, 19002, US

(21) Appl. No.: 10/781,576

(22) Filed: Feb. 18, 2004

(30) Foreign Application Priority Data
Feb. 18, 2003 (EP) 03003177.7

(51) Int. Cl. C11D 1/00

(52) U.S. Cl. 428/402

(57) ABSTRACT

Laundry treatment preparations comprising a microcapsule comprised of an inner core comprised of a soil repellant and an outer shell comprised of a membrane. Textile fibers finished with compositions containing the microcapsules according to the invention are not readily resoiled.

### CROSS-REFERENCE TO RELATED APPLICATIONS

This application claims priority of EP 03003177.7, filed on Feb. 18, 2003.

### BACKGROUND OF THE INVENTION

This invention relates generally to laundry treatment preparations and, more particularly, to new preparations containing microencapsulated active components which make resoiling more difficult, to a process for treating textiles and the use of special microencapsulated active components for finishing laundry.

Laundry treatment preparations are expected by the modern consumer to meet steadily increasing demands. The days when it was regarded as sufficient to remove various stains completely from various fabrics at low temperatures have gone. Today, standard laundry treatment preparations have to satisfy the most complex requirements beginning with care for the laundry and ending with care for the wearer. The unending number of patent publications on this subject shows that the industry is still far away from fulfilling the demands of consumers to their complete satisfaction.

In this connection, it is to a certain extent a detail that consumers expect not only the complete removal of soil from textiles, but also protection against resoiling. In fact, such soil repellants do exist and are marketed by various manufacturers. They are all polymers which essentially contain ethylene terephthalate and/or polyethylene glycol terephthalate groups. However, a disadvantage of such polymers is that they cannot be formulated at will. Separation tends to occur, particularly in the event of prolonged storage and under the influence of temperature, and—in the most favorable case—can result in the preparations becoming cloudy. Such products have to be vigorously shaken and remixed before use which is scant reward for the normal consumer particularly interested in buying them. Transparent formulations in particular, which permanently retain this appearance, can only be produced in this way with serious limitations, if at all.

Accordingly, the problem addressed by the present invention was to is provide new water-containing preparations with which textiles could be finished in such a way that resoiling would be prevented or at least made more difficult (soil-repellent effect) without any of the disadvantages of the prior art arising. More particularly, the active components would be easy to incorporate and the resulting water-containing preparations would be stable in storage. Another wish was to use active substances that would have additional positive effects in regard to textile finishing.

### BRIEF SUMMARY OF THE INVENTION

One aspect of the present invention pertains to a composition comprising a microcapsule comprised of an inner core comprised of a soil repellant and an outer shell comprised of a membrane. Another aspect of the present invention pertains to cleaning compositions containing the microcapsules according to the invention. Yet another aspect of the present invention pertains to processes for the preparation of a microcapsule. One such process is comprised of the steps of: (1) providing a first aqueous solution comprising a gel wherein the solution is maintained at the boiling point; (2) providing a second aqueous solution comprised of chitosan and a soil repellant; (3) forming a matrix by adding the second solution to the first while the first solution is maintained at the boiling point; (4) contacting the matrix with an aqueous solution of an anionic polymer to form microcapsules. A variation of the process is comprised of the steps of (1) providing a first aqueous solution comprising a gel wherein the solution is maintained at the boiling point; (2) providing a second aqueous solution comprised of an anionic polymer and a soil repellant; (3) forming a matrix by adding the second solution to the first while the first solution is maintained at the boiling point; (4) contacting the matrix with an aqueous solution of chitosan to form microcapsules.

Textile fibers finished with compositions containing the microcapsules according to the invention are not readily resoiled.

### BRIEF DESCRIPTION OF THE SEVERAL VIEWS OF THE DRAWINGS

Not applicable.

### DETAILED DESCRIPTION OF THE INVENTION

Other than in the claims and in the operating examples, or where otherwise indicated, all numbers expressing quantities of ingredients or reaction conditions used herein are to be understood as modified in all instances by the term “about”.

The present invention relates to water-containing preparations, for example fabric softeners, liquid detergents or laundry aftertreatment preparations, containing microencapsulated active components, characterized in that the active components are substances which prevent the resoiling of textiles or at least make it more difficult.

The problem of unsatisfactory formulatability and poor stability in storage has been solved by incorporating the known active components in microencapsulated form in the preparations according to the invention. Transparent preparations with long-term stability can be produced in this way. By additionally incorporating dyes in the microcapsules, it is possible, for example, to obtain transparent preparations which contain the active components in the form of clearly visible, for example blue- or red-colored spherical structures, which can be desirable on aesthetic grounds because it is a direct visual indication to the consumer of the presence of the active components. The microencapsulated active components are absorbed onto the fibers; the capsules are gradually broken up mechanically and then release the active component in portions. A preferred embodiment of the invention is characterized by the use of microencapsulated active components where the membrane consists entirely or at least predominantly of chitosan. Chitosan also tends to be absorbed onto fibers. Since chitosan has care properties and antibacterial properties, the desired additional benefit is achieved through the use of chitosan microcapsules.

Active Components

Suitable soil repellants are substances which preferably contain ethylene terephthalate and/or polyethylene glycol terephthalate groups, the molar ratio of ethylene terephthalate to polyethylene glycol terephthalate being in the range from 50:50 to 90:10. The molecular weight of the linking polyethylene glycol units is, in particular, in the range from 750 to 5,000, i.e. the degree of ethoxylation of the polymers containing polyethylene glycol groups may be ca.15 to 100. The polymers are distinguished by an average molecular weight of about 5,000 to 200,000 and may have a block structure, although they preferably have a random structure. Preferred polymers are those with ethylene terephthalate/polyethylene glycol terephthalate molar ratios of about 65:35 to about 90:10 and preferably in the range from about 70:30 to 80:20. Other preferred polymers contain linking polyethylene glycol units with a molecular weight of 750 to 5,000 and preferably in the range from 1,000 to about 3,000 and a molecular weight of the polymer of about 10,000 to about 50,000. Examples of commercially available polymers are the products Milase® T (ICI) or Repelotex® SRP 3 (Rhône-Poulenc).

Microcapsules

“Microcapsules” are understood by the expert to be spherical aggregates with a diameter of about 0.0001 to about 5 mm which contain at least one solid or liquid core surrounded by at least one continuous membrane. More precisely, they are finely dispersed liquid or solid phases coated with film-forming polymers, in the production of which the polymers are deposited onto the material to be encapsulated after emulsification and coacervation or interfacial polymerization. In another process, molten waxes are absorbed in a matrix (“microsponge”) which, as microparticles, may be additionally coated with film-forming polymers. The microscopically small capsules, also known as nanocapsules, can be dried in the same way as powders. Besides single-core microcapsules, there are also multiple-core aggregates, also known as microspheres, which contain two or more cores distributed in the continuous membrane material. In addition, single-core or multiple-core microcapsules may be surrounded by an additional second, third etc. membrane. The membrane may consist of natural, semisynthetic or synthetic materials. Natural membrane materials are, for example, gum arabic, agar agar, agarose, maltodextrins, alginic acid and salts thereof, for example sodium or calcium alginate, fats and fatty acids, cetyl alcohol, collagen, chitosan, lecithins, gelatin, albumin, shellac, polysaccharides, such as starch or dextran, polypeptides, protein hydrolyzates, sucrose and waxes. Semisynthetic membrane materials are inter alia chemically modified celluloses, more particularly cellulose esters and ethers, for example cellulose acetate, ethyl cellulose, hydroxypropyl cellulose, hydroxypropyl methyl cellulose and carboxymethyl cellulose, and starch derivatives, more particularly starch ethers and esters. Synthetic membrane materials are, for example, polymers, such as polyacrylates, polyamides, polyvinyl alcohol or polyvinyl pyrrolidone.

Examples of known microcapsules are the following commercial products (the membrane material is shown in brackets) Hallcrest Microcapsules (gelatin, gum arabic), Coletica Thalaspheres (maritime collagen), Lipotec Millicapseln (alginic acid, agar agar), Induchem Unispheres (lactose, microcrystalline cellulose, hydroxypropylmethyl cellulose), Unicerin C30 (lactose, microcrystalline cellulose, hydroxypropylmethyl cellulose), Kobo Glycospheres (modified starch, fatty acid esters, phospholipids), Softspheres (modified agar agar), Kuhs Probiol Nanospheres (phospholipids), Primaspheres and Primasponges (chitosan, alginates) and Primasys (phospholipids).

As already explained, a particular advantage lies in the use of microencapsulated active components of which the membrane is at least partly formed by chitosan. Chitosan microcapsules and processes for their production are described in U.S. Pat. No. 6,534,091, the entire contents of which are incorporated herein by reference and in WO 01/01926, WO 01/01928 and WO 01/01929. Microcapsules with mean diameters of 0.0001 to 5, preferably 0.001 to 0.5 and more particularly 0.005 to 0.1 mm, which consist of a membrane and a matrix containing the active components, may be obtained, for example, by

(a1) preparing a matrix from gel formers, chitosans and active components,

(a2) optionally dispersing the matrix in an oil phase and

(a3) treating the dispersed matrix with aqueous solutions of anionic polymers and optionally removing the oil phase in the process or

(b1) preparing a matrix from gel formers, anionic polymers and active components,

(b2) optionally dispersing the matrix in an oil phase and

(b3) treating the dispersed matrix with aqueous chitosan solutions and optionally removing the oil phase in the process or

(c1) processing aqueous active-component preparations with oil components in the presence of emulsifiers to form o/w emulsions,

(c2) treating the emulsions thus obtained with aqueous solutions of anionic polymers,

(c3) contacting the matrix thus obtained with aqueous chitosan solutions and

(c4) removing the encapsulated products thus obtained from the aqueous phase.

Gel Formers

Preferred gel formers for the purposes of the invention are substances which are capable of forming gels in aqueous solution at temperatures above 40° C. Typical examples of such gel formers are heteropolysaccharides and proteins. Preferred thermogelling heteropoly-saccharides are agaroses which may be present in the form of the agar agar obtainable from red algae, even together with up to 30% by weight of non-gel-forming agaropectins. The principal constituent of agaroses are linear polysaccharides of D-galactose and 3,6-anhydro-L-galactose with alternate β-1,3- and β-1,4-glycosidic bonds. The heteropolysaccharides preferably have a molecular weight of 110,000 to 160,000 and are both odorless and tasteless. Suitable alternatives are pectins, xanthans (including xanthan gum) and mixtures thereof. Other preferred types are those which—in 1% by weight aqueous solution—still form gels that do not melt below 80° C. and solidify again above 40° C. Examples from the group of thermogelling proteins are the various gelatins.

Chitosans

Chitosans are biopolymers which belong to the group of hydrocolloids. Chemically, they are partly deacetylated chitins differing in their molecular weights which contain the following—idealized—monomer unit:

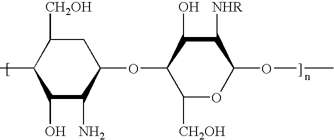

In contrast to most hydrocolloids, which are negatively charged at biological pH values, chitosans are cationic biopolymers under these conditions. The positively charged chitosans are capable of interacting with oppositely charged surfaces and are therefore used in cosmetic hair-care and body-care products and pharmaceutical preparations. Chitosans are produced is from chitin, preferably from the shell residues of crustaceans which are available in large quantities as inexpensive raw materials. In a process described for the first time by Hackmann et al., the chitin is normally first deproteinized by addition of bases, demineralized by addition of mineral acids and, finally, deacetylated by addition of strong bases, the molecular weights being distributed over a broad spectrum. Preferred types are those which have an average molecular weight of 10,000 to 500,000 dalton or 800,000 to 1,200,000 dalton and/or a Brookfield viscosity (1% by weight in glycolic acid) below 5,000 mPas, a degree of deacetylation of 80 to 88% and an ash content of less than 0.3% by weight. In the interests of better solubility in water, the chitosans are generally used in the form of their salts, preferably as glycolates.

Oil Phase

Before formation of the membrane, the matrix may optionally be dispersed in an oil phase. Suitable oils for this purpose are, for example, Guerbet alcohols based on fatty alcohols containing 6 to 18 and preferably 8 to 10 carbon atoms, esters of linear C₆₋₂₂ fatty acids, with linear C₆₋₂₂ fatty alcohols, esters of branched C₆₋₁₃ carboxylic acids with linear C₆₋₂₂ fatty alcohols such as, for example, myristyl myristate, myristyl palmitate, myristyl stearate, myristyl isostearate, myristyl oleate, myristyl behenate, myristyl erucate, cetyl myristate, cetyl palmitate, cetyl stearate, cetyl isostearate, cetyl oleate, cetyl behenate, cetyl erucate, stearyl myristate, stearyl palmitate, stearyl stearate, stearyl isostearate, stearyl oleate, stearyl behenate, stearyl erucate, isostearyl myristate, isostearyl palmitate, isostearyl stearate, isostearyl isostearate, isostearyl oleate, isostearyl behenate, isostearyl oleate, oleyl myristate, oleyl palmitate, oleyl stearate, oleyl isostearate, oleyl oleate, oleyl behenate, oleyl erucate, behenyl myristate, behenyl palmitate, behenyl stearate, behenyl isostearate, behenyl oleate, behenyl behenate, behenyl erucate, erucyl myristate, erucyl palmitate, erucyl stearate, erucyl isostearate, erucyl oleate, erucyl behenate and erucyl erucate. Also suitable are esters of linear C₆₋₂₂ fatty acids with branched alcohols, more particularly 2-ethyl hexanol, esters of hydroxycarboxylic acids with linear or branched C₆₋₂₂ fatty alcohols, more especially Dioctyl Malate, esters of linear and/or branched fatty acids with polyhydric alcohols (for example propylene glycol, dimer diol or trimer triol) and/or Guerbet alcohols, triglycerides based on C₆₋₁₀ fatty acids, liquid mono-/di-/triglyceride mixtures based on C₆₋₁₈ fatty acids, esters of C₆₋₂₂ fatty alcohols and/or Guerbet alcohols with aromatic carboxylic acids, more particularly benzoic acid, esters of C₂₋₁₂ dicarboxylic acids with linear or branched alcohols containing 1 to 22 carbon atoms or polyols containing 2 to 10 carbon atoms and 2 to 6 hydroxyl groups, vegetable oils, branched primary alcohols, substituted cyclohexanes, linear and branched C₆₋₂₂ fatty alcohol carbonates, Guerbet carbonates, esters of benzoic acid with linear and/or branched C₆₋₂₂ alcohols (for example Finsolv® TN), linear or branched, symmetrical or nonsymmetrical dialkyl ethers containing 6 to 22 carbon atoms per alkyl group, ring opening products of epoxidized fatty acid esters with polyols, silicone oils and/or aliphatic or naphthenic hydrocarbons, for example squalane, squalene or dialkyl cyclohexanes.

Anionic Polymers

The function of the anionic polymers is to form membranes with the chitosans. Preferred anionic polymers are salts of alginic acid. The alginic acid is a mixture of carboxyl-containing polysaccharides with the following idealized monomer unit:

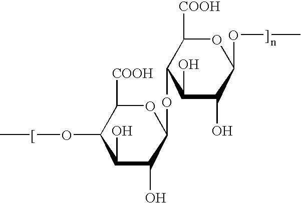

The average molecular weight of the alginic acid or the alginates is in the range from 150,000 to 250,000. Salts of alginic acid and complete and partial neutralization products thereof are understood in particular to be the alkali metal salts, preferably sodium alginate (“algin”), and the ammonium and alkaline earth metal salts. Mixed alginates, for example sodium/magnesium or sodium/calcium alginates, are particularly preferred. In an alternative embodiment of the invention, however, anionic chitosan derivatives, for example carboxylation and above all succinylation products are also suitable for this purpose. Alternatively, poly(meth)acrylates with average molecular weights of 5,000 to 50,000 dalton and the various carboxymethyl celluloses may also be used. Instead of the anionic polymers, anionic surfactants or low molecular weight inorganic salts, such as pyrophosphates for example, may also be used for forming the membrane.

Emulsifiers

Suitable emulsifiers are, for example, nonionic surfactants from at least one of the following groups:

products of the addition of 2 to 30 mol ethylene oxide and/or 0 to 5 mol propylene oxide onto linear C₈₋₂₂ fatty alcohols, C₁₂₋₂₂ fatty acids and alkyl phenols containing 8 to 15 carbon atoms in the alkyl group and alkylamines containing 8 to 22 carbon atoms in the alkyl group;

alkyl and/or alkenyl oligoglycosides containing 8 to 22 carbon atoms in the alkyl group and ethoxylated analogs thereof;

addition products of 1 to 15 mol ethylene oxide onto castor oil and/or hydrogenated castor oil;

addition products of 15 to 60 mol ethylene oxide onto castor oil and/or hydrogenated castor oil;

partial esters of glycerol and/or sorbitan with unsaturated, linear or saturated, branched fatty acids containing 12 to 22 carbon atoms and/or hydroxycarboxylic acids containing 3 to 18 carbon atoms and addition products thereof with 1 to 30 mol ethylene oxide;

partial esters of polyglycerol (average degree of self-condensation 2 to 8), polyethylene glycol (molecular weight 400 to 5,000), trimethylolpropane, pentaerythritol, sugar alcohols (for example sorbitol), alkyl glucosides (for example methyl glucoside, butyl glucoside, lauryl glucoside) and polyglucosides (for example cellulose) with saturated and/or unsaturated, linear or branched fatty acids containing 12 to 22 carbon atoms and/or hydroxycarboxylic acids containing 3 to 18 carbon atoms and addition products thereof with 1 to 30 mol ethylene oxide;

mixed esters of pentaerythritol, fatty acids, citric acid and fatty alcohol and/or mixed esters of fatty acids containing 6 to 22 carbon atoms, methyl glucose and polyols, preferably glycerol or polyglycerol;

mono-, di- and trialkyl phosphates and mono-, di- and/or tri-PEG-alkyl phosphates and salts thereof;

wool wax alcohols;

polysiloxane/polyalkyl/polyether copolymers and corresponding derivatives;

block copolymers, for example Polyethyleneglycol-30 Dipolyhydroxystearate;

polymer emulsifiers, for example Pemulen types (TR-1)Y, TR-2) from Goodrich;

polyalkylene glycols and

glycerol carbonate.

To produce the microcapsules, a 1 to 10 and preferably 2 to 5% by weight aqueous solution of the gel former, preferably agar agar, is normally prepared and heated under reflux. A second aqueous solution containing the chitosan in quantities of 0.1 to 2 and preferably 0.25 to 0.5% by weight and the active substances in quantities of 0.1 to 25 and preferably 0.25 to 10% by weight is added in the boiling heat, preferably at 80 to 100° C.; this mixture is called the matrix. Accordingly, the charging of the microcapsules with active substances may also comprise 0.1 to 25% by weight, based on the weight of the capsules. If desired, water-insoluble constituents, for example inorganic pigments, may be added at this stage to adjust viscosity, generally in the form of aqueous or aqueous/alcoholic dispersions. In addition, to emulsify or disperse the active substances, it can be useful to add emulsifiers and/or solubilizers to the matrix. After its preparation from gel former, chitosan and active substances, the matrix may optionally be very finely dispersed in an oil phase with intensive shearing in order to produce small particles in the subsequent encapsulation process. It has proved to be particularly advantageous in this regard to heat the matrix to temperatures in the range from 40 to 60° C. while the oil phase is cooled to 10 to 20° C. The actual encapsulation, i.e. formation of the membrane by contacting the chitosan in the matrix with the anionic polymers, takes place in the last, again compulsory step. To this end, it is advisable to wash the matrix optionally dispersed in the oil phase with an aqueous ca. 1 to 50 and preferably 10 to 15% by weight aqueous solution of the anionic polymer and, if necessary, to remove the oil phase either at the same time or afterwards. The resulting aqueous preparations generally have a microcapsule content of 1 to 10% by weight. In some cases, it can be of advantage for the solution of the polymers to contain other ingredients, for example emulsifiers or preservatives. After filtration, microcapsules with a mean diameter of preferably about 1 mm are obtained. It is advisable to sieve the capsules to ensure a uniform size distribution. The microcapsules thus obtained may have any shape within production-related limits, but are preferably substantially spherical. Alternatively, the anionic polymers may also be used for the preparation of the matrix and encapsulation may be carried out with the chitosans.

An alternative process for the production of the microcapsules according to the invention comprises initially preparing an o/w emulsion which, besides the oil component, water and the active components, contains an effective quantity of emulsifier. To form the matrix, a suitable quantity of an aqueous anionic polymer solution is added to this preparation with vigorous stirring. The membrane is formed by addition of the chitosan solution. The entire process preferably takes place at a mildly acidic pH of 3 to 4. If necessary, the pH is adjusted by addition of mineral acid. After formation of the membrane, the pH is increased to a value of 5 to 6, for example by addition of triethanolamine or another base. This results in an increase in viscosity which can be supported by addition of other thickeners such as, for example, polysaccharides, more particularly xanthan gum, guar guar, agar agar, alginates and tyloses, carboxymethyl cellulose and hydroxyethyl cellulose, relatively high molecular weight polyethylene glycol mono- and diesters of fatty acids, polyacrylates, polyacrylamides and the like. Finally, the microcapsules are separated from the aqueous phase, for example by decantation, filtration or centrifuging.

Aqueous Preparations

The preparations normally contain microencapsulated active components in quantities of 0.1 to 10, preferably 1 to 8 and more particularly 2 to 5% by weight, based on the preparation. In the most simple case, the preparations are aqueous solutions which merely contain the microcapsules and optionally suitable thickeners. This is the case with laundry aftertreatment preparations for example. In other cases, i.e. fabric softeners or liquid detergents, the preparations may also contain, above all, anionic, nonionic, cationic and/or amphoteric or zwitterionic surfactants.

Anionic Surfactants

Typical examples of anionic surfactants are soaps, alkyl benzene-sulfonates, alkane sulfonates, olefin sulfonates, alkyl ether sulfonates, glycerol ether sulfonates, α-methyl ester sulfonates, sulfofatty acids, alkyl sulfates, fatty alcohol ether sulfates, glycerol ether sulfates, hydroxy mixed ether sulfates, monoglyceride(ether)sulfates, fatty acid amide(ether)sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acyl amino acids such as, for example, acyl lactylates, acyl tartrates, acyl glutamates and acyl aspartates, alkyl oligoglucoside sulfates, protein fatty acid condensates (especially wheat-based vegetable products) and alkyl(ether)phosphates. If the anionic surfactants contain polyglycol ether chains, the polyglycol ether chains may have a conventional homolog distribution, although they preferably have a narrow homolog distribution. Alkyl benzenesulfonates, alkyl sulfates, soaps, alkanesulfonates, olefin sulfonates, methyl ester sulfonates and mixtures thereof are preferably used.

Alkyl Benenesulfonates

Preferred alkyl benzenesulfonates correspond to formula (I):

R¹-Ph-SO₃X (I)

in which R¹ is a branched, but preferably linear alkyl group containing 10 to 18 carbon atoms, Ph is a phenyl group and X is an alkali metal and/or alkaline earth metal, ammonium, alkylammonium, alkanolammonium or glucammonium. Of these alkyl benzenesulfonates, dodecyl benzene-sulfonates, tetradecyl benzenesulfonates, hexadecyl benzenesulfonates and technical mixtures thereof in the form of the sodium salts are particularly suitable.

Alkyl and/or Alkenyl Sulfates

Alkyl and/or alkenyl sulfates, which are also often referred to as fatty alcohol sulfates, are understood to be the sulfation products of primary and/or secondary alcohols which preferably correspond to formula (II):

R²O—SO₃X (II)

in which R² is a linear or branched, aliphatic alkyl and/or alkenyl group containing 6 to 22 and preferably 12 to 18 carbon atoms and X is an alkali metal and/or alkaline earth metal, ammonium, alkylammonium, alkanol-ammonium or glucammonium. Typical examples of alkyl sulfates which may be used in accordance with the invention are the sulfation products of caproic alcohol, caprylic alcohol, capric alcohol, 2-ethylhexyl alcohol, lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol and erucyl alcohol and the technical mixtures thereof obtained by high-pressure hydrogenation of technical methyl ester fractions or aldehydes from Roelen's oxosynthesis. The sulfation products may advantageously be used in the form of their alkali metal salts, more especially their sodium salts. Alkyl sulfates based on C_{16/18} tallow fatty alcohols or vegetable fatty alcohols with a comparable C-chain distribution in the form of their sodium salts are particularly preferred. In the case of branched primary types, the alcohols are oxoalcohols which are obtainable, for example, by reacting carbon monoxide and hydrogen on α-olefins by the Shop process. Corresponding alcohol mixtures are commercially available under the trade names of Dobanol® or Neodol®. Suitable alcohol mixtures are Dobanol 91®, 23®, 25® and 45®. Another possibility are the oxoalcohols obtained by the standard oxo process of Enichema or Condea in which carbon monoxide and hydrogen are added onto olefins. These alcohol mixtures are a mixture of highly branched alcohols and are commercially available under the name of Lial®. Suitable alcohol mixtures are Lial 91®, 111®, 123®, 125®, 145®.

Soaps

Soaps are understood to be fatty acid salts corresponding to formula (III);

R³CO—OX (III)

in which R³CO is a linear or branched, saturated or unsaturated acyl group containing 6 to 22 and preferably 12 to 18 carbon atoms and X is alkali and/or alkaline earth metal, ammonium, alkylammonium or alkanolammonium. Typical examples are the sodium, potassium, magnesium, ammonium and triethanolammonium salts of caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof. Coconut oil fatty acid or palm kernel oil fatty acid in the form of their sodium or potassium salts are preferably used.

Nonionic Surfactants

Typical examples of nonionic surfactants are fatty alcohol polyglycol ethers, alkylphenol polyglycol ethers, fatty acid polyglycol esters, fatty acid amide polyglycol ethers, fatty amine polyglycol ethers, alkoxylated triglycerides, mixed ethers and mixed formals, alk(en)yl oligoglycosides, fatty acid-N-alkyl glucamides, protein hydrolyzates (more particularly wheat- based vegetable products), polyol fatty acid esters, sugar esters, sorbitan is esters, polysorbates and amine oxides. If the nonionic surfactants contain polyglycol ether chains, the polyglycol ether chains may have a conventional homolog distribution, although they preferably have a narrow homolog distribution. Fatty alcohol polyglycol ethers, alkoxylated fatty acid lower alkyl esters or alkyl oligoglycosides are preferably used.

Fatty Alcohol Polyglycol Ethers

Preferred fatty alcohol polyglycol ethers correspond to formula (IV):

R⁴O(CH₂CHR⁵O)ₙ₁H (IV)

in which R⁴ is a linear or branched alkyl and/or alkenyl group containing 6 to 22 and preferably 12 to 18 carbon atoms, R⁵ is hydrogen or methyl and n1 is a number of 1 to 20. Typical examples are products of the addition of, on average, 1 to 20 and preferably 5 to 10 mol ethylene and/or propylene oxide onto caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcohol, erucyl alcohol and brassidyl alcohol and technical mixtures thereof. Products of the addition of 3, 5 or 7 mol ethylene oxide onto technical cocofatty alcohols are particularly preferred.

Alkoxylated Fatty Acid Esters

Suitable alkoxylated fatty acid lower alkyl esters are surfactants corresponding to formula (V):

R⁶CO—(OCH₂CHR⁷)ₙ₂OR⁸ (V)

in which R⁶CO is a linear or branched, saturated and/or unsaturated acyl group containing 6 to 22 carbon atoms, R⁷ is hydrogen or methyl, R⁸ is a linear or branched alkyl group containing 1 to 4 carbon atoms and n2 is a number of 1 to 20. Typical examples are the formal insertion products of, on average, 1 to 20 and preferably 5 to 10 mol ethylene and/or propylene oxide into the methyl, ethyl, propyl, isopropyl, butyl and tert butyl esters of caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof. The products are normally prepared by insertion of the alkylene oxides into the carbonyl ester bond in the preserice of special catalysts, for example calcined hydrotalcite. Reaction products of on average 5 to 10 mol ethylene oxide into the ester bond of technical cocofatty acid methyl esters are particularly preferred.

Alkyl and/or Alkenyl Oligoglycosides

Alkyl and alkenyl oligoglycosides, which are also preferred nonionic surfactants, normally correspond to formula (VI):

R⁹O-[G]ₚ (VI)

in which R⁸ is an alkyl and/or alkenyl group containing 4 to 22 carbon atoms, G is a sugar unit containing 5 or 6 carbon atoms and p is a number of 1 to 10. They may be obtained by the relevant methods of preparative organic chemistry. The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides. The index p in general formula (VI) indicates the degree of oligomerization (DP), i.e. the distribution of mono- and oligoglycosides, and is a number of 1 to 10. Whereas p in a given compound must always be an integer and, above all, may assume a value of 1 to 6, the value p for a certain alkyl oligoglycoside is an analytically determined calculated quantity which is generally a broken number. Alkyl and/or alkenyl oligoglycosides having an average degree of oligomerization p of 1.1 to 3.0 are preferably used. Alkyl and/or alkenyl oligoglycosides having a degree of oligomerization of less than 1.7 and, more particularly, between 1.2 and 1.4 are preferred from the applicational point of view. The alkyl or alkenyl radical R⁹ may be derived from primary alcohols containing 4 to 11 and preferably 8 to 10 carbon atoms. Typical examples are butanol, caproic alcohol, caprylic alcohol, capric alcohol and undecyl alcohol and the technical mixtures thereof obtained, for example, in the hydrogenation of technical fatty acid methyl esters or in the hydrogenation of aldehydes from Roelen's oxosynthesis. Alkyl oligoglucosides having a chain length of C₈ to C₁₀ (DP=1 to 3), which are obtained as first runnings in the separation of technical C₈₋₁₈ coconut oil fatty alcohol by distillation and which may contain less than 6% by weight of C₁₂ alcohol as an impurity, and also alkyl oligo-glucosides based on technical C_{9/11}; oxoalcohols (DP=1 to 3) are preferred. In addition, the alkyl or alkenyl radical R⁹ may also be derived from primary alcohols containing 12 to 22 and preferably 12 to 14 carbon atoms. Typical examples are lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and technical mixtures thereof which may be obtained as described above. Alkyl oligoglucosides based on hydrogenated C_{12/14} cocoalcohol with a DP of 1 to 3 are preferred.

Cationic Surfactants

Typical examples of cationic surfactants are, in particular, tetraalkylammonium compounds such as, for example, dimethyl distearyl ammonium chloride or Hydroxyethyl Hydroxycetyl Dimmonium Chloride (Dehyquart E) and esterquats. Estersquats are typically constituents of fabric softeners. Examples of esterquats are quaternized fatty acid triethanolamine ester salts corresponding to formula (VII):

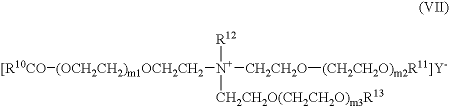

in which R¹⁰CO is an acyl group containing 6-to 22 carbon atoms, R¹¹ and R¹² independently of one another represent hydrogen or have the same meaning as R¹⁰OCO, R¹¹ is an alkyl group containing 1 to 4 carbon atoms or a (CH₂CH₂O)ₘ₄H group, m1, m2 and m3 together stand for 0 or numbers of 1 to 12, m4 is a number of 1 to 12 and Y is halide, alkyl sulfate or alkyl phosphate. Typical examples of esterquats which may be used in accordance with the invention are products based on caproic acid, caprylic acid, capric acid, lauric acid, myristic acid, palmitic acid, isostearic acid, stearic acid, oleic acid, elaidic acid, arachic acid, behenic acid and erucic acid and the technical mixtures thereof obtained for example in the pressure hydrolysis of natural fats and oils. Technical C_{12/18} cocofatty acids and, in particular, partly hydrogenated C_{16/18} tallow or palm oil fatty acids and high-elaidic C_{16/18} fatty acid cuts are preferably used. To produce the quaternized esters, the fatty acids and the triethanolamine may be used in a molar ratio of 1.1:1 to 3:1. With the performance properties of the esterquats in mind, a ratio of 1.2:1 to 2.2:1 and preferably 1.5:1 to 1.9:1 has proved to be particularly advantageous. The preferred esterquats are technical mixtures of mono-, di- and triesters with an average degree of esterification of 1.5 to 1.9 and are derived from technical C_{16/18} tallow or palm oil fatty acid (iodine value 0 to 40). In performance terms, quaternized fatty acid triethanolamine ester salts corresponding to formula (VII), in which R¹⁰CO is an acyl group containing 16 to 18 carbon atoms, R¹¹ has the same meaning as R¹⁰OCO, R¹² is hydrogen, R¹³ is a methyl group, m1, m2 and m3 stand for 0 and Y stands for methyl sulfate, have proved to be particularly advantageous.

Other suitable esterquats besides the quaternized fatty acid triethanolamine ester salts are quaternized ester salts of fatty acids with diethanolalkyamines corresponding to formula (VIII):

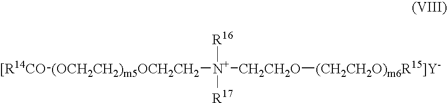

in which R¹⁴CO is an acyl group containing 6 to 22 carbon atoms, R¹⁵ is hydrogen or has the same meaning as R¹⁴CO, R¹⁶ and R¹⁷ independently of one another are alkyl groups containing 1 to 4 carbon atoms, m5 and m6 together stand for 0 or numbers of 1 to 12 and Y stands for halide, alkyl sulfate or alkyl phosphate. Finally, another group of suitable esterquats are the quaternized ester salts of fatty acids with 1,2-dihydroxypropyl dialkylamines corresponding to formula (IX):

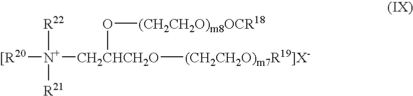

in which R¹⁸CO is an acyl group containing 6 to 22 carbon atoms, R¹⁹ is hydrogen or has the same meaning as R¹⁸CO, R²⁰, R²¹ and R²² independently of one another are alkyl groups containing 1 to 4 carbon atoms, m7 and m8 together stand for 0 or numbers of 1 to 12 and X again stands for halide, alkyl sulfate or alkyl phosphate. Finally, other suitable esterquats are substances in which the ester bond is replaced by an amide bond and which—preferably based on diethylenetriamine—correspond to formula (X):

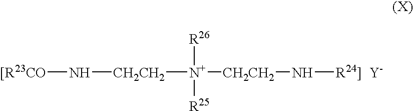

in which R²³CO is an acyl group containing 6 to 22 carbon atoms, R²⁴ is hydrogen or has the same meaning as R²³CO, R²⁵ and R²⁶ independently of one another are alkyl groups containing 1 to 4 carbon atoms and Y is again halide, alkyl sulfate or alkyl phosphate. Amide esterquats such as these are commercially obtainable, for example, under the name of Incroquat® (Croda).

Amphoteric or Zwitterionic Surfactants

Examples of suitable amphoteric or zwitterionic surfactants are alkyl betaines, alkyl amidobetaines, aminopropionates, aminoglycinates, imidazolinium betaines and sulfobetaines. Examples of suitable alkyl betaines are the carboxyalkylation products of secondary and, in particular, tertiary amines corresponding to formula (XI):

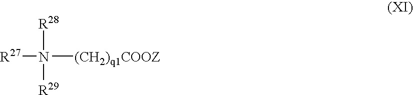

in which R²⁷ represents alkyl and/or alkenyl groups containing 6 to 22 carbon atoms, R²⁸ represents hydrogen or alkyl groups containing 1 to 4-carbon atoms, R²⁹ represents alkyl groups containing 1 to 4 carbon atoms, q1 is a number of 1 to 6 and Z is an alkali metal and/or alkaline earth metal or ammonium. Typical examples are the carboxymethylation products of hexylmethyl amine, hexyldimethyl amine, octyidimethyl amine, decyldimethyl amine, dodecylmethyl amine, dodecyldimethyl amine, dodecylethylmethyl amine, C_{12/14} cocoalkyldimethyl amine, myristyldimethyl amine, cetyidimethyl amine, stearyidimethyl amine, stearylethylmethyl amine, oleyidimethyl amine, C_{16/18} tallow alkyldimethyl amine and technical mixtures thereof. Also suitable are carboxyalkylation products of amidoamines corresponding to formula (XII):

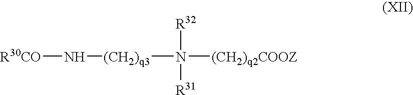

in which R³⁰CO is an aliphatic acyl group containing 6 to 22 carbon atoms and 0 or 1 to 3 double bonds, R³¹ is hydrogen or represents alkyl groups containing 1 to 4 carbon atoms, R³² represents alkyl groups containing 1 to 4 carbon atoms, q2 is a number of 1 to 6, q3 is a number of 1 to 3 and Z is again an alkali metal and/or alkaline earth metal or ammonium. Typical examples are reaction products of fatty acids containing 6 to 22 carbon atoms, namely caproic acid, caprylic acid, capric acid, lauric acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof, with N,N-dimethylaminoethyl amine, N,N-dimethylaminopropyl amine, N,N-diethylaminoethyl amine and N,N-diethylaminopropyl amine which are condensed with sodium chloroacetate. A condensation product of C_{8/18}-cocofatty acid-N,N-dimethylaminopropyl amide with sodium chloroacetate is preferably used. Imidazolinium betaines may also be used. These compounds are also known compounds which may be obtained, for example, by cyclizing condensation of 1 or 2 moles of fatty acid with polyfunctional amines such as, for example, aminoethyl ethanolamine, (AEEA) or diethylenetriamine. The corresponding carboxyalkylation products are mixtures of different open-chain betaines. Typical examples are condensation products of the fatty acids mentioned above with AEEA, preferably imidazolines based on lauric acid or—again—C_{12/14} cocofatty acid which are subsequently betainized with sodium chloroacetate.

Thickeners

In a preferred embodiment of the invention, it is desirable to give the preparations such a high viscosity that the microcapsules remain stably dispersed, i.e. do not sediment with time. Accordingly, the expression “elevated viscosity” is understood to mean a rheology which ensures the stabilization of the microcapsules in the aqueous (surfactant) phase. Viscosities of this order (as determined with a Brookfield RVT viscosimeter, 20° C., spindle 1, 10 r.p.m.) are normally above 100 mPa.s and preferably above 500 mPas, more preferably in the range from 200 to 2,000 mPa.s and most preferably in the range from 500 to 1,000 mPas. Suitable thickeners are any substances which give the formulations a correspondingly high viscosity. However, preferred thickeners are polymeric compounds because they are capable of building up a three-dimensional network, in which the microcapsules are stabilized, in the aqueous preparations. Typical examples are Aerosil types (hydrophilic silicas), polysaccharides, more especially xanthan gum, guar-guar, agar-agar, alginates and tyloses, carboxymethyl cellulose and hydroxyethyl and hydroxypropyl cellulose, also relatively high molecular weight polyethylene glycol monoesters and diesters of fatty acids, polyacrylates (for example Carbopols® and Pemulen types [Goodrich]; Synthalens® [Sigma]; Keltrol types [Kelco]; Sepigel types [Seppic]; Salcare types [Allied Colloids]), polyacrylamides, polymers, polyvinyl alcohol and polyvinyl pyrrolidone. Other consistency factors which have proved to be particularly effective are bentonites, for example Bentone® Gel VS-5PC (Rheox) which is a mixture of cyclopentasiloxane, Disteardimonium Hectorite and propylene carbonate. The percentage content of these thickeners in the water-containing preparations may be between 0.1 and 5% by weight and is preferably from. 0.5 to 3% by weight and more particularly from 1 to 2% by weight.

Commercial Applications

The present invention also relates to a process for preventing the resoiling of textiles, in which the fibers, yarns or flat textile materials are finished with microencapsulated active components selected from the group consisting of polymers (soil repellants) containing ethylene terephthalate and/or polyethylene glycol terephthalate groups, and to the use of microencapsulated polymers (soil repellants) containing ethylene terephthalate and/or polyethylene glycol terephthalate groups for the production of laundry after treatment preparations.

The following examples are meant to illustrate but not to limit the invention.

### EXAMPLES

### Example 1

In a 500 ml three-necked flask equipped with a stirrer and reflux condenser, 3 g agar agar were dissolved in 200 ml boiling water. First a solution of 10 g glycerol in 90 ml water and then a preparation of 2.5 g sodium alginate in the form of a 10% by weight aqueous solution, 3 g Milease® T, 0.5 g Phenonip® and 0.5 g Polysorbate-20 (Tween® 20, ICl) in 64 g water were added to the mixture over a period of 30 mins. with intensive stirring. The matrix obtained was-filtered, heated to 60° C. and added dropwise to a 1% by weight solution of chitosan glycosylate in water. The preparations were then sieved to obtain microcapsules with the same diameter.

### Example 2

In a 500 ml three-necked flask equipped with a stirrer and reflux condenser, 3 g agar agar were dissolved in 200 ml boiling water. First a solution of 10 g glycerol in 90 ml water and then a preparation of 2.5 g sodium alginate in the form of a 10% by weight aqueous solution, 3 g Repelotex® SRP 3, 0.5 g Phenonip® and 0.5 g Polysorbate-20 (Tween® 20, ICl) in 64 g water were added to the mixture over a period of 30 mins with intensive stirring. The matrix obtained was filtered, heated to 60° C. and added dropwise to a 1% by weight solution of chitosan glycosylate in water. The preparations were then sieved to obtain microcapsules with the same diameter.

Table 1 below shows a number of Formulation Examples. Formulations 1,2) are liquid detergents, formulation 3) is a fabric softener and formulation 4) a laundry aftertreatment preparation.

TABLE 1
Composition of water-containing preparations

| Composition | 1 | 2 | 3 | 4 |
|---|---|---|---|---|
| C_{12/18} cocoalcohol + 5EO | 25.0 | 25.0 | — | — |
| Dehydol ® LT5 | | | | |
| C_{12/18} cocoalcohol + 7EO | 10.0 | — | — | — |
| Dehydol ® LT7 | | | | |
| Mixed ether¹⁾ | — | 10.0 | — | — |
| Dehypol ® KE 3447 | | | | |
| Dipalmoylmethylethoxymonium | — | — | 25.0 | — |
| Methosulfate | | | | |
| Dehyquart ® AU 54 | | | | |
| Carbopol | 0.49 | 0.49 | 0.49 | |
| Dye | 0.01 | 0.01 | 0.01 | |
| Microcapsules, Example 1 | 1.0 | — | 1.0 | — |
| Microcapsules, Example 2 | — | 1.0 | — | 1.0 |

| | |
|---|---|
| Water | to 100 |

¹⁾Reaction product of 1,2-dodecene epoxide and octanol + 1PO + 4OEO

What is claimed is:

1. A composition comprising a microcapsule comprised of an inner core comprised of a soil repellant and an outer shell comprised of a membrane.

2. The composition of claim 1 wherein the soil repellant is comprised of an ethylene terephthalate polymer, a polyethyleneglycol terephthalate polymer or a combination thereof.

3. The composition of claim 2 wherein the mole ratio of ethylene terephthalate/polyethyleneglycol terephthalate is from 65:35 to 90:10.

4. The composition of claim 1 wherein the mean diameter of the microcapsule is from about 0.0001 to about 5 mm.

5. The composition of claim 1 wherein the repellant is present in an amount of from about 0.1 to about 10% by weight of the composition.

6. A composition comprising: (1) water and (2) a microcapsule comprised of an inner core comprised of a soil repellant and an outer shell comprised of a membrane.

7. The composition of claim 6 wherein the soil repellant is comprised of an ethylene terephthalate polymer, a polyethyleneglycol terephthalate polymer or a combination thereof.

8. The composition of claim 7 wherein the mole ratio of ethylene terephthalate/polyethyleneglycol terephthalate is from 65:35 to 90:10.

9. The composition of claim 6 wherein the mean diameter of the microcapsule is from about 0.0001 to about 5 mm.

10. The composition of claim 6 further comprising an anionic, nonionic, cationic and/or amphoteric or a zwitterionic surfactant.

11. The composition of claim 6 further comprising a thickener.

12. A process for the preparation of a microcapsule comprising the steps of: (1) providing a first aqueous solution comprising a gel wherein the solution is maintained at the boiling point; (2) providing a second aqueous solution comprised of chitosan and a soil repellant; (3) forming a matrix by adding the second solution to the first while the first solution is maintained at the boiling point; (4) contacting the matrix with an aqueous solution of an anionic polymer to form microcapsules.

13. A process for the preparation of a microcapsule comprising the steps of: (1) providing a first aqueous solution comprising a gel wherein the solution is maintained at the boiling point; (2) providing a second aqueous solution comprised of chitosan and a soil repellant; (3) forming a matrix by adding the second solution to the first while the first solution is maintained at the boiling point; (4) dispersing the matrix in an oil phase; (5) contacting the matrix with an aqueous solution of an anionic polymer to form microcapsules.

14. A process for the preparation of a microcapsule comprising the steps of: (1) providing a first aqueous solution comprising a gel wherein the solution is maintained at the boiling point; (2) providing a second aqueous solution comprised of an anionic polymer and a soil repellant; (3) forming a matrix by adding the second solution to the first while the first solution is maintained at the boiling point; (4) contacting the matrix with an aqueous solution of chitosan to form microcapsules.

15. A process for the preparation of a microcapsule comprising the steps of: (1) providing a first aqueous solution comprising a gel wherein the solution is maintained at the boiling point; (2) providing a second aqueous solution comprised of an anionic polymer and a soil repellant; (3) forming a matrix by adding the second solution to the first while the first solution is maintained at the boiling point; (4) dispersing the matrix in an oil phase; (5) contacting the matrix with an aqueous solution of chitosan to form microcapsules.

16. The composition of claim 6 wherein the amount of component (2) is from about 0.1 to about 10% by weight of the composition.

17. The composition of claim 16 wherein the amount of component (2) is from about 1 to about 8% by weight of the composition.

18. The composition of claim 17 wherein the amount of component (2) is from about 2 to about 5% by weight of the composition.

19. A process for preventing the resoiling of textile fibers comprising finishing textile fibers with a composition comprising a microcapsule comprised of an inner core comprised of a soil repellant and an outer shell comprised of a membrane.

20. The composition of claim 1 wherein the soil repellant is comprised of an ethylene terephthalate polymer, a polyethyleneglycol terephthalate polymer or a combination thereof.

21. The composition of claim 2 wherein the mole ratio of ethylene terephthalate/polyethyleneglycol terephthalate is from 65:35 to 90:10.

22. The composition of claim 1 wherein the mean diameter of the microcapsule is from about 0.0001 to about 5 mm.

23. The composition of claim 1 wherein the repellant is present in an amount of from about 0.1 to about 10% by weight of the composition.
